(19) United States
(12) Patent Application Publication
(10) Pub. No.: US 2022/0300308 A1
(43) Pub. Date: Sep. 22, 2022

(54) AUTOMATIC SELECTION OF LANGUAGE FOR GRAPHICAL USER INTERFACE OF NETWORK DEVICE

(71) Applicant: ARRIS ENTERPRISES LLC, Suwanee, GA (US)

(72) Inventors: Yingxiang QIU, Shenzhen, Guangdong (CN); Rui CHEN, Shenzhen, Guangdong (CN); Na ZHOU, Shenzhen, Guangdong (CN); Lijie NIU, Shenzhen, Guangdong (CN); Tingting WANG, Shenzhen, Guangdong (CN)

(21) Appl. No.: 17/264,379

(22) PCT Filed: Jan. 31, 2020
(86) PCT No.: PCT/CN2020/074118

§ 371 Date: Jan. 29, 2021

(51) Int. Cl. G06F 9/451; G06F 40/40; G06F 3/0481; H04L 67/02

(52) U.S. Cl. CPC G06F 9/454; G06F 40/40; G06F 3/0481; H04L 67/02

(57) ABSTRACT

An electronic device, a method, and a program for automatically selecting a language setting of a user interface of the electronic device are disclosed. The electronic device includes memory, and a processor. Language information is obtained by the electronic device from the client device. The language information may include a language field value from the client device. The language field value may relate to a web browser or an operating system of the client device. The language information may be part of an HTTP GET request. A configuration file stored in the memory is modified so as to automatically select the language setting of the user interface of the electronic device based on the language information from the client device.

### BACKGROUND

A network device connects a client device to a network. The network device may include a graphical user interface (GUI) displaying graphical elements such as icons, cursors, and windows to a user so as to facilitate interaction of the user with the network device. A GUI may be accessible via a web browser and may support multiple languages (such as English or Spanish).

Typically, a default language for the GUI is preprogrammed into the network device by an Internet service provider (ISP) based on the target location of the network device. For example, a network device to be deployed in the United States may have American English preselected as the default language for the GUI of the network device. Other existing solutions detect the current location of the user and query the user as to whether it is desired to change the language for the GUI of the network device to the common language of the current location of the user. However, if the user's native or preferred language is different from the common language of the target location of the network device or the current location of the user, then a non-preferred or possibly even unintelligible language will be selected.

Further existing solutions require the user to manually reconfigure the GUI so as to feature another language that preferred over the default language. The user must therefore find the login GUI, find the appropriate controller, and then manually change the language setting. However, this is burdensome due to the number of steps required and also because the user may not be able to understand how to reconfigure the GUI if the user is not fluent in the default language.

Thus, it would be advantageous and an improvement over existing solutions to provide an electronic device, a method, and a program for automatically selecting a language setting of a user interface of the electronic device.

### SUMMARY

An electronic device, a method, and a program for automatically selecting a language setting of a user interface of the electronic device are disclosed in the present application.

The electronic device comprises:
memory; and
a processor;
wherein the processor is configured to:
obtain language information from the client device; and
modify a configuration file stored in the memory so as to automatically select the language setting of the user interface of the electronic device based on the language information from the client device.

The method comprises:
obtaining language information from the client device; and
modifying a configuration file stored in memory of the electronic device so as to automatically select a language setting of a user interface of the electronic device based on the language information from the client device.

In an embodiment described in the present application, a non-transitory computer-readable recording medium has recorded thereon a program embodying the features of the method discussed above.

The electronic device, the method, and the program tailor the user interface to a particular user by automatically selecting the language setting of the user interface of the electronic device based on the language information from the client device.

A user's preferred language can be determined, for example, from the language of a web browser or an operating system (OS) on the client device that is being used by the user. Accordingly, the language information can include a language field value of the web browser or the OS of the client device.

### BRIEF DESCRIPTION OF THE DRAWINGS

FIG. 1 is a system diagram including a network device 100, a client device 200, and a network 300.

FIG. 2 is a block diagram of the network device 100.

FIG. 3 is a sequence diagram illustrating exemplary operations of the network device 100 and the client device 200.

### DETAILED DESCRIPTION

Exemplary embodiments will be described in detail below with reference to the drawings. The description and drawings are provided so that a person skilled in the art can fully understand the present disclosure and are not intended to limit the subject matter recited in the claims.

The electronic device, the method, and the program disclosed herein address and solve the following problems:

How to tailor the language for the user interface to individual users.

How to improve the user experience by increasing convenience.

How to reduce the rate of user error.

How to increase development efficiency by eliminating the requirement to provide different default languages for different countries.

The electronic device, the method, and the program disclosed herein solve the problems identified above and provide an efficient and effective solution to automatically select a language setting of a user interface of the electronic device.

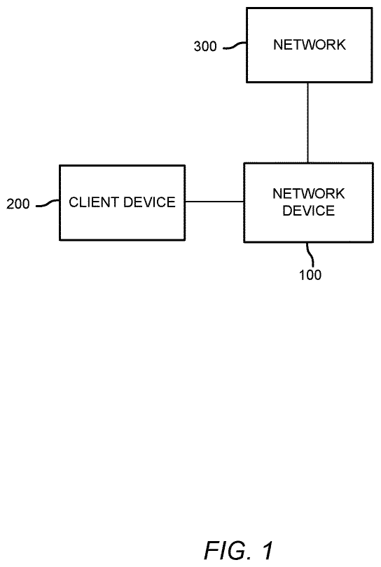

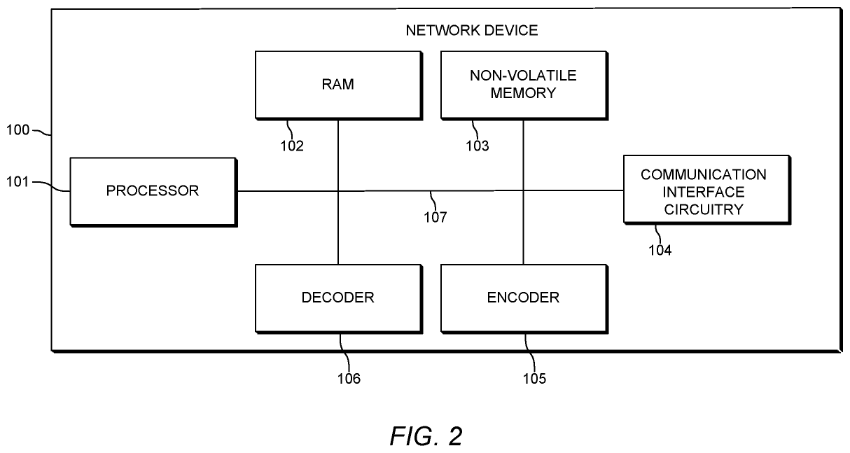

FIG. 1 is a system diagram including a network device 100, a client device 200, and a network 300. The network device 100 includes components and circuits (e.g., as shown in FIG. 2) capable of converting signals received from a service provider into signals usable by the client device 200 for providing access to the network 300. The service provider includes, for example, an ISP, a cable television provider, a satellite television provider, and multiple system operators (MSOs). The network device 100 and the client device 200 generally use any standard protocol to communicate with each other. One such example of the protocol is Hypertext Transfer Protocol (HTTP), although the protocol is not limited to HTTP, and other standard protocols can be used to achieve the network device and client device communication. The network device 100 may be in the form of a modem. Alternatively or additionally, the network device 100 may be in the form of an access point or a router that can function in a Local Area Network (LAN) whereby the client device 200 can be connected over Wi-Fi and/or Ethernet to the network device 100. The operation of the components and circuits of the network device 100 will be discussed in more detail with reference to FIG. 2.

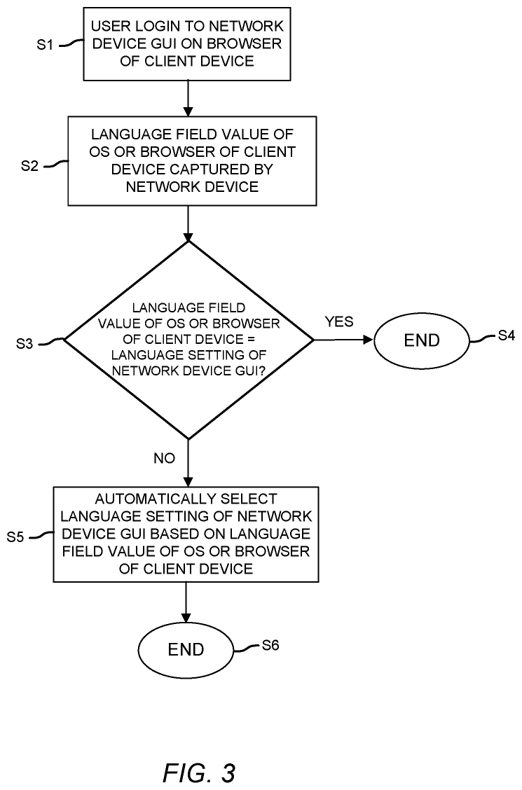

For ease of discussion, the network device 100 may be a stand-alone modem and/or a router, but the present disclosure is not intended to be limited only to this type of network device and alternatively the network device 100 can be integrated directly into a consumer device such as a television, a computer, or any other consumer device, such as an electronically equipped appliance. The client device 200 includes components and circuits that are capable of executing and displaying data received from the network device 100. The client device 200 may include, but is not limited to, a computer, a portable device, an electronic tablet, a smart phone, a television and/or any other consumer device. The client device 200 can be in the form of a stand-alone device, or may be incorporated in another device or appliance. The operation of the components and circuits of the client device 200 will be discussed in more detail with reference to FIG. 3.

FIG. 2 is a block diagram of the network device 100. The network device 100 may include a processor 101, RAM 102, non-volatile memory 103, communication interface circuitry 104, an encoder 105, a decoder 106, and a communication bus 107 through which various components in the network device 100 are connected for communicating data therebetween.

The processor 101 may be a dedicated controller, CPU, microprocessor, etc., capable of controlling the operation of the components and circuits of the network device 100. The RAM 102 may be implemented as a working memory for the processor 101, and the non-volatile memory 103 can be provided for storage of program code, operational parameters, language information, and other information. Default operational parameters in the form of one or more configuration files may be programmed into the non-volatile memory 103. For example, an ISP may preprogram the one or more configuration files in the non-volatile memory 103 prior to deployment. The default operational parameters may include a language setting for the GUI of the network device 100.

The GUI of the network device 100 may present a series of menus, tasks, or windows so as to enable the user to change settings or operational parameters of the network device 100. The settings or operational parameters may relate to language, broadband, WAN, LAN, routing, remote management, blocking, filtering, security, etc. For example, a user may access the GUI of the network device 100 by opening a web browser on the client device 200 and entering a Uniform Resource Locator (URL) or an Internet Protocol (IP) address assigned to the network device 100.

The network device 100 transmits and/or receives data to/from the network 300 via the communication interface circuitry 104. For example, the communication interface circuitry 104 can include one or more connectors, such as coaxial cable connectors, RF connectors or Ethernet connectors. One of the connectors of the communication interface circuitry 104 can be connected to a content service provider, such as an ISP, by terrestrial antenna, satellite dish, or wired cable. The encoder 105 may encode signals received from the network 300 and the decoder 106 may decode the signals so as to convert the signals from the network 300 into signals usable by the client device 200.

The network device 100 transmits and/or receives data to/from the client device 200 via the communication interface circuitry 104. For example, the communication interface circuitry 104 can use an Ethernet standard for wired connections for communicating with the client device 200. Alternatively or additionally, the communication interface circuitry 104 can incorporate wireless networking capability using Wi-Fi standards for communicating with the client device 200 using a wireless communication connection.

Information communicated between the network device 100 and the client device 200 may include language information received in an HTTP GET or a HEAD request transmitted between the network device 100 and the client device 200. The language information may be subsequently stored in the RAM 101 or the non-volatile memory 102 of the network device 100. The GET or HEAD requests are used as part of an HTTP protocol such as HTTP/2 and are used as a method of retrieving information from a client device. The language information (such as the language field value of the OS or the web browser) of the client device 200 can be returned as part of a HTTP GET request by the client device 200.

The network device 100 may include any other element such as a Bluetooth transceiver, a tuner, a Wi-Fi transceiver, a display, an IR receiver and/or a speaker.

FIG. 3 is a sequence diagram illustrating an exemplary method and algorithm for automatically selecting a language setting of a user interface of an electronic device. The sequence shown in FIG. 3 can be implemented in the exemplary network device 100 shown in FIGS. 1 & 2. For example, the method and algorithm can be implemented by a program stored in the RAM 102 or the non-volatile memory 103 and executed by the processor 101, such that the processor 101 controls the operations of the components and circuits of the network device 100 to perform operations of the method and algorithm.

In Step S1, a user logs into the GUI of the network device 100 using the client device 200. The user opens a web browser with the client device 200 and inputs the URL or the IP address of the GUI of the network device 100.

In Step S2, language information including a language field value from the client device 200 is obtained by the network device 100. The obtainment of information from the client device 200 can be effected by an HTTP GET request transmitted to the network device 100 from the client device 200. For example, the web browser of the client device 200 can send the HTTP GET request to the network device 100 upon login to the GUI of the network device 100 by the user. The language information from the client device 200 may include a language field value of an OS or a web browser of the client device 200. The language field may be, for example, “Accept-Language” and the value of the language field may be, for example, “es” which represents Spanish.

In Step S3, once the HTTP GET request is received by the communication interface circuitry 104, it is determined whether the language field value from the client device 200 is the same as the language setting of the GUI of the network device 100. If the language field value from the client device 200 is the same as the language setting of the GUI of the network device 100, then the sequence ends in Step S4 (for example, if the language field value of the client device 200 is “es” and the language setting of the GUI of the network device 100 is Spanish). If the language field value from the client device is not the same as the language setting of the GUI of the network device 100 (for example, if the language field value of the client device 200 is “es” and the language setting of the GUI of the network device 100 is American English), then the sequence proceeds to S5.

In Step S5, the processor 101 modifies a configuration file stored in the memory 103 so as to automatically select the language setting of the GUI of the network device 100 based on the language field value from the client device 200. For example, the language setting of the GUI of the network device 100 may be updated from American English to Spanish so as to match the “es” language field value of the client device 200.

In Step S6, the sequence ends.

Although embodiments featuring an HTTP GET request and a language field value are described above, the language setting of the GUI of the network device 100 can be updated using any known protocol and any known language data, language metadata, or other language information of the client device 200.

As noted above, the present invention can be implemented not only as a device or a system, but also as a method for automatically selecting a language setting of a user interface of an electronic device. The present invention can be implemented as a program on a non-transitory computer-readable medium for causing a computer, such as the processor in an electronic device or the processor in a client device, to execute the steps described in FIG. 3. The non-transitory computer-readable recording medium could be, for example, a CD-ROM, DVD, Blu-ray disc, or an electronic memory device.

The present invention may be implemented as any combination of a device, a system, a method, an integrated circuit, and a computer program on a non-transitory computer readable recording medium. The processor and any other parts of the electronic devices may be implemented as Integrated Circuits (IC), Application-Specific Integrated Circuits (ASIC), or Large Scale Integrated circuits (LSI), system LSI, super LSI, or ultra LSI components which perform a part or all of the functions of the electronic devices, such as modems.

Each of the parts of the present invention can be implemented using many single-function components, or can be one component integrated using the technologies described above. The circuits may also be implemented as a specifically programmed general purpose processor, CPU, a specialized microprocessor such as a Digital Signal Processor that can be directed by program instructions on a memory, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

The present invention may be a non-transitory computer-readable recording medium having recorded thereon a program embodying the methods/algorithms discussed above for instructing the processor to perform the methods/algorithms. Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory.

The sequence of the steps included in the above described algorithms is exemplary, and algorithms having a sequence other than the above described sequences are contemplated. Moreover, steps, or parts of the algorithm, may be implemented simultaneously or in parallel.

Moreover, while the disclosed embodiments are described with respect to operations within a network device and/or a client device, the present invention relates equally to operation in the cloud.

It is also contemplated that the implementation of the components of the present invention can be done with any newly arising technology that may replace any of the above implementation technologies.

We claim:

1. An electronic device for automatically selecting a language setting of a user interface of the electronic device, the electronic device comprising:
memory; and
a processor;
wherein the processor is configured to:
obtain language information from the client device; and
modify a configuration file stored in the memory so as to automatically select the language setting of the user interface of the electronic device based on the language information from the client device.

2. The electronic device of claim 1, wherein the user interface is a GUI.

3. The electronic device of claim 2, wherein the processor is configured to obtain the language information from the client device upon user login to the GUI on a web browser of the client device.

4. The electronic device of claim 1, wherein the language information from the client device includes a language field value of a web browser of the client device.

5. The electronic device of claim 1, wherein the language information from the client device includes a language field value of an OS of the client device.

6. The electronic device of claim 1, wherein the language information is part of an HTTP GET request.

7. The electronic device of claim 1, wherein the electronic device is a modem.

8. The electronic device of claim 1, wherein the electronic device is a router.

9. A method implemented on an electronic device for automatically selecting a language setting of a user interface of the electronic device, the method comprising:
obtaining language information from the client device; and
modifying a configuration file stored in memory of the electronic device so as to automatically select the language setting of the user interface of the electronic device based on the language information from the client device.

10. The method of claim 9, wherein the user interface is a GUI.

11. The method of claim 10, wherein the obtaining the language information from the client device is performed upon user login to the GUI on a web browser of the client device.

12. The method of claim 9, wherein the language information from the client device includes a language field value of a web browser of the client device.

13. The method of claim 9, wherein the language information from the client device includes a language field value of an OS of the client device.

14. The method of claim 9, wherein the language information is part of an HTTP GET request.

15. A non-transitory computer readable storage medium having stored thereon a program implemented on an electronic device for automatically selecting a language setting of a user interface of the electronic device, the program causing the electronic device to perform steps comprising:
obtaining language information from the client device; and
modifying a configuration file stored in memory of the electronic device so as to automatically select the language setting of the user interface of the electronic device based on the language information from the client device.

16. The non-transitory computer readable storage medium of claim 15, wherein the user interface is a GUI.

17. The non-transitory computer readable storage medium of claim 16, wherein the obtaining the language information from the client device is performed upon user login to the GUI on a web browser of the client device.

18. The non-transitory computer readable storage medium of claim 15, wherein the language information from the client device includes a language field value of a web browser of the client device.

19. The non-transitory computer readable storage medium of claim 15, wherein the language information from the client device includes a language field value of an OS of the client device.

20. The non-transitory computer readable storage medium of claim 15, wherein the language information is part of an HTTP GET request.
